(19) United States
(12) Patent Application Publication
(10) Pub. No.: US 2025/0005282 A1
(43) Pub. Date: Jan. 2, 2025

(54) DOMAIN ENTITY EXTRACTION FOR PERFORMING TEXT ANALYSIS TASKS

(71) Applicant: Amazon Technologies, Inc., Seattle, WA (US)

(72) Inventors: John Colton Moriarty, Seattle, WA (US); Saket Dingliwal, Kirkland, WA (US); Karthik Gopalakrishnan, Sunnyvale, CA (US); Sravan Babu Bodapati, Fremont, CA (US); Katrin Kirchhoff, Seattle, WA (US); Lei Xu, Jersey City, NJ (US)

(73) Assignee: Amazon Technologies, Inc., Seattle, WA (US)

(21) Appl. No.: 18/344,764

(22) Filed: Jun. 29, 2023

(51) Int. Cl. G06F 40/284; G06F 16/34

(52) U.S. Cl. CPC G06F 40/284; G06F 16/345

(57) ABSTRACT

Domain specialty instructions may be generated for performing text analysis tasks. An input text may be received for performing a text analysis task. One or more domain entities may be extracted from the input text using a machine learning model trained to recognize entities of a domain in a given text. The one or more domain entities may be inserted as part of generating instructions to perform the text analysis task using a pre-trained machine learning model fine-tuned to the domain. The pre-trained machine learning model may be caused to perform the text analysis task using the generated instructions and a result of the text analysis task may be provided.

### BACKGROUND

Large language models (LLMs) are becoming increasingly capable of performing tasks such as answering questions expressed in natural language, summarizing text and the like. In some cases, however, LLMs may introduce incorrect or nonsensical statements referred to as “hallucinations” in their output. The presence of hallucinations in LLM-generated text can in general lead to lowering end users' trust in LLM capabilities, and is some use cases (e.g., in scenarios in which LLMs are used for health-related applications) may even lead to non-trivial negative impacts on health outcomes.

### BRIEF DESCRIPTION OF THE DRAWINGS

FIG. 1 illustrates a logical block diagram of domain entity extraction for performing text analysis tasks, according to some embodiments.

FIG. 2 illustrates an example provider network that may implement a medical audio summarization service that implements domain entity extraction for performing text analysis tasks, according to some embodiments.

FIG. 3 illustrates a logical block diagram of different interactions to perform text summarizations using domain entity extraction, according to some embodiments.

FIG. 4 illustrates a logical block diagram of fine-tuning a pre-trained large language model for performing text summarizations using domain entity extraction, according to some embodiments.

FIG. 5 illustrates a logical block diagram of extracted domain entities included instructions to perform a summarization task using a large language model, according to some embodiments.

FIG. 6 illustrates a high-level flowchart of various methods and techniques to implement domain entity extraction for performing text analysis tasks, according to some embodiments.

FIG. 7 illustrates a high-level flowchart of various methods and techniques to implement fine-tuning a pre-trained large language model for a domain entity extraction for performing text analysis tasks, according to some embodiments.

FIG. 8 illustrates an example system to implement the various methods, techniques, and systems described herein, according to some embodiments.

While embodiments are described herein by way of example for several embodiments and illustrative drawings, those skilled in the art will recognize that embodiments are not limited to the embodiments or drawings described. It should be understood, that the drawings and detailed description thereto are not intended to limit embodiments to the particular form disclosed, but on the contrary, the intention is to cover all modifications, equivalents and alternatives falling within the spirit and scope as described by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to.

It will also be understood that, although the terms first, second, etc. may be used herein to describe various elements, these elements should not be limited by these terms. These terms are only used to distinguish one element from another. For example, a first contact could be termed a second contact, and, similarly, a second contact could be termed a first contact, without departing from the scope of the present invention. The first contact and the second contact are both contacts, but they are not the same contact.

### DETAILED DESCRIPTION OF EMBODIMENTS

Various techniques for domain entity extraction for performing text analysis tasks are described herein. Text analysis tasks may be performed as part of many different natural language or other text processing applications. Text may be obtained, for example, from documents or generated from audio or video transcripts, among other sources. Because these sources may vary across a wide variety of domains (e.g., different branches of knowledge, such as different scientific branches, professional domains (e.g., legal, medical, finance), art, literature, and so on, machine learning models upon which text analysis tasks may rely in order to perform part (or all) of different analysis tasks may encounter esoteric or specialized semantics that may not have been adequately observed in training machine learning models.

For example, text analysis tasks performed in the healthcare domain may include tasks to generate medical summaries of doctor-patient conversations from clinical visits. These summaries may capture a patient's reason for visit, history of illness as well as the doctor's assessment and plan for the patient. The summaries may be created using a special class of machine learning models, generative large language models (LLM) that are tuned to follow natural language instructions describing any task. This class of LLMs (e.g., InstructGPT) are typically trained on massive general-purpose text corpora and on a variety of tasks, including summarization. However, such generative models are prone to factual inconsistencies such as hallucination and incompleteness which can be exacerbated during fine-tuning depending on the characteristics of the fine-turning data.

For example, in the healthcare domain, Subjective, Objective, Assessment and Plan (SOAP) notes, which are generated for documenting doctor-patient conversations, annotations contain two such characteristics that can encourage hallucination and incompleteness. First, the terminology used in the annotated summary may differ slightly from what was used during the conversation despite being semantically similar. Training with these differences may cause the large language model to learn to translate between terminology (e.g., the semantically similar terminology) which when done incorrectly may cause hallucination. Second, annotations are frequently incomplete in their coverage of all medically relevant items in the conversation. This incompleteness causes a corresponding incompleteness in the model predictions. Since healthcare is a critical domain, there is a business need to generate factually correct and complete summaries. Other domains that perform text analysis tasks, such as summaries, may also rely upon accurate large language model performance (e.g., legal or other professional domains, various science or technology domains, etc.). Techniques for domain entity extraction for performing text analysis tasks reduce hallucination and improve summary completeness by guiding the performance of task analysis with the terms present in the text (e.g., guiding generation of SOAP note summaries with the clinical concepts present in the conversation).

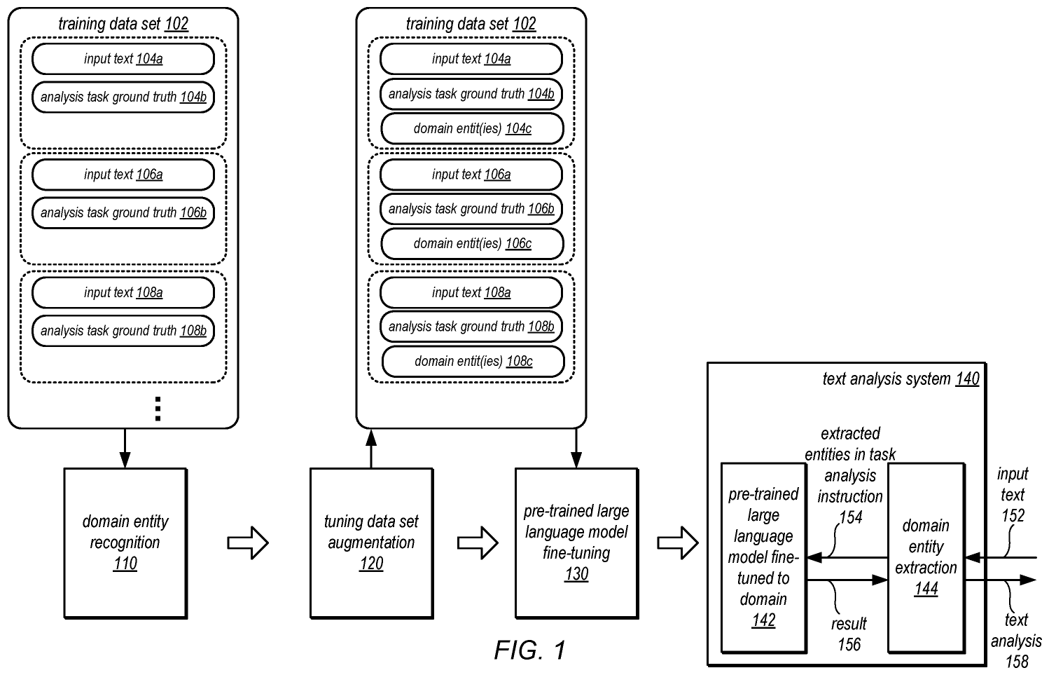

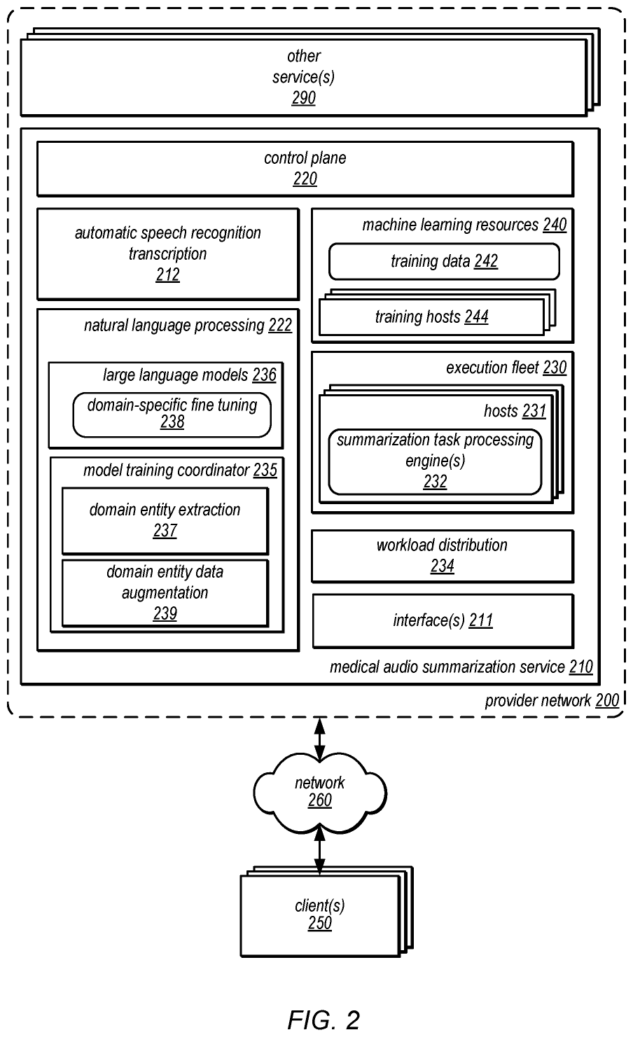

FIG. 1 illustrates a logical block diagram of domain entity extraction for performing text analysis tasks, according to some embodiments. Different domains for different areas of text analysis, such as health care as mentioned above and discussed below with regard to FIG. 2-5 or other areas (e.g., legal, scientific disciplines or categories, etc.) may be involved when performing text analysis. In order to ensure that appropriate domain entities are included in text analysis tasks without causing “translation” from input text to domain entities to occur by a pre-trained large language mode, domain entity recognition 110 may be implemented. Domain entity recognition 110, which may be a locally hosted (e.g., on a same system as text analysis system 140) or remotely hosted machine learning model that is trained to recognize entities in given text for a domain (e.g., a different models for medical, legal, individual scientific disciplines, and so on). Domain entity recognition 110 may evaluate the analysis task ground truth 104b, 106b, 108b in training data set 102 for corresponding input texts 104a. 106a, and 108a, to recognize domain entities in the ground truth data. For example, entity recognition machine learning models (e.g., Named Entity Recognition (NER) models) may be implemented as part of domain entity recognition 110 to analyze task ground truth labels to identify key terms or other entities that are significant to the domain.

Once the domain entities are identified, then the domain entities may be passed to tuning data set augmentation 120. Tuning data set augmentation 120 may augment training data set 102 to include the domain entities, as indicated at 104c, 106c, and 108c. The augmented training data set 1020 can then be used to perform fine-tuning on a pre-trained large language model, as indicated at 130. For example, fine-tuning techniques may include adding instructions to include the domain entit(ies) (e.g., 104c, 106c, and 108c in training requests) in the response as part of performing the text analysis task. Such techniques utilize the externally provided domain entit(ies) to guide text analysis tasks when semantically similar language is detected instead of causing the pre-trained large language model to develop and use an internal translation between semantically similar domain entities (which could cause hallucinations or incomplete information as discussed above).

Text analysis system 140 that performs text analysis on the different domains to have domain entity information used to guide the text analysis to greater factual accuracy and prevent translation errors that lead to hallucinations as discussed above. Pre-trained large language model 142 that is fine tuned to the domain can then be used to perform text analysis tasks, such as summarization, comparison, question answering, or adding introductory or conclusory sections, among other text analysis tasks, using domain instructions that are generated for input text that have domain entities extracted, as indicated at 144, and then sent, as indicated at 154, to pre-trained model that is fine-tuned to the domain 142, to perform the text analysis tasks and return a result 156 which can be passed back as text analysis 158.

Please note that the previous description of domain entity extraction for performing text analysis tasks is a logical illustration and thus is not to be construed as limiting as to the implementation of a task analysis system.

This specification continues with a general description of a provider network that implements multiple different services, including a medical audio processing service, which may implement domain entity extraction for performing text analysis tasks. Then various examples of, including different components, or arrangements of components that may be employed as part of implementing the services are discussed. A number of different methods and techniques to implement domain entity extraction for performing text analysis tasks are then discussed, some of which are illustrated in accompanying flowcharts. Finally, a description of an example computing system upon which the various components, modules, systems, devices, and/or nodes may be implemented is provided. Various examples are provided throughout the specification.

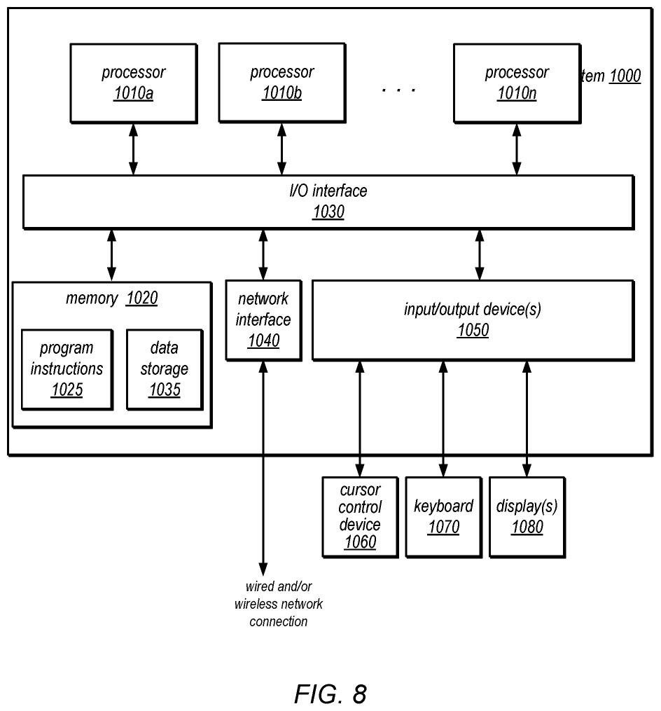

FIG. 2 illustrates an example provider network that may implement a medical audio summarization service that implements domain entity extraction for performing text analysis tasks, according to some embodiments. In some embodiments, a provider network 200 may be a private or closed system or may be set up by an entity such as a company or a public sector organization to provide one or more services (such as various types of cloud-based storage or computing services) accessible via the Internet and/or other networks to clients 250, in some embodiments. The provider network 200 may be implemented in a single location or may include numerous data centers hosting various resource pools, such as collections of physical and/or virtualized computer servers, storage devices, networking equipment and the like (e.g., computing system 1000 described below with regard to FIG. 8), needed to implement and distribute the infrastructure and services offered by the provider network 200. For example, the provider network 200 may implement various computing resources or services, such as a medical audio summarization service 210, and/or any other type of network-based services 290 (which may include a virtual compute service and various other types of storage, database or data processing, analysis, communication, event handling, visualization, data cataloging, data ingestion (e.g., ETL), and security services), in some embodiments.

In various embodiments, the medical audio summarization service 100 may implement interface(s) 211 to allow clients (e.g., client(s) 250 or clients implemented internally within provider network 200, such as a client application hosted on another provider network service like an event driven code execution service or virtual compute service) to interact with the medical audio summarization service 210. The interface(s) 211 may be one or more of graphical user interfaces, programmatic interfaces that implement Application Program Interfaces (APIs) and/or command line interfaces, such as input interfaces, user setting interfaces, output interfaces, and/or output APIs.

In at least some embodiments, summarization task engine(s) 232 may be implemented on hosts 231 to initiate tasks for automatic speech recognition transcription 212 and natural language processing 222. The workload distribution 234, comprising one or more computing devices, may be responsible for selecting the particular host 231 in execution fleet 230 that is to be used to implement a summarization task engine(s) 232 to be used to perform a given job. The medical audio summarization service 210 may implement control plane 220 to perform various control operations to implement the features of medical audio summarization service 210. For example, the control plane 220 may monitor the health and performance of computing resources (e.g., computing system 1000) used to perform tasks to service requests at different components, such as workload distribution 234, hosts 231, machine learning resources 240, automatic speech recognition transcription 212, and natural language processing engine 222. The control plane 220 may, in some embodiments, arbitrate, balance, select, or dispatch requests to different components in various embodiments.

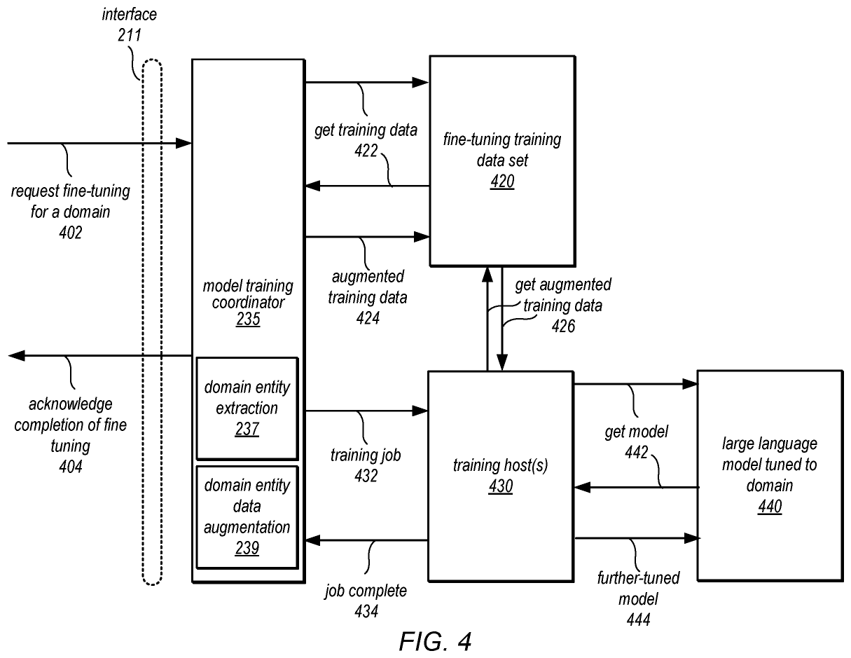

The medical audio summarization service 210 may utilize machine learning resources 240. The machine learning resources 240 may include various frameworks, libraries, applications, or other tools for training or tuning machine learning models utilized as part of medical audio summarization service 210. For example, large language model 236 may be trained or fine-tuned (e.g., with domain-specific fine tuning), as discussed according to the techniques below for FIG. 4.

Generally speaking, clients 250 may encompass any type of client that can submit network-based requests to provider network 200 via network 260, including requests for the medical audio summarization service 210 (e.g., a request to generate a transcript and summary of a medical conversation). For example, a given client 250 may include a suitable version of a web browser, or may include a plug-in module or other type of code module that can execute as an extension to or within an execution environment provided by a web browser.

In some embodiments, a client 250 may provide access to provider network 200 to other applications in a manner that is transparent to those applications. Clients 250 may convey network-based services requests (e.g., requests to interact with services like medical audio summarization service 210) via network 260, in some embodiments. In various embodiments, network 260 may encompass any suitable combination of networking hardware and protocols necessary to establish network-based-based communications between clients 250 and provider network 200. For example, network 260 may generally encompass the various telecommunications networks and service providers that collectively implement the Internet. Network 260 may also include private networks such as local area networks (LANs) or wide area networks (WANs) as well as public or private wireless networks, in one embodiment. For example, both a given client 250 and provider network 200 may be respectively provisioned within enterprises having their own internal networks. In such an embodiment, network 260 may include the hardware (e.g., modems, routers, switches, load balancers, proxy servers, etc.) and software (e.g., protocol stacks, accounting software, firewall/security software, etc.) necessary to establish a networking link between the given client 250 and the Internet as well as between the Internet and provider network 200. It is noted that in some embodiments, clients 250 may communicate with provider network 200 using a private network rather than the public Internet.

In some embodiments, medical audio summarization is performed, such as by a medical audio summarization service 210, and may resemble embodiments as shown in FIG. 2. In some embodiments, an input interface of the medical audio summarization service 210 may receive an indication of a medical conversation to be summarized (with various features, such as making a summary conforming to a user preferred style). In some embodiments, the input interface may receive an audio file including metadata of a medical conversation. For example, the input interface may receive an audio file of a doctor-patient conversation with metadata indicating that the conversation was in the context of a diabetes diagnosis. In some embodiments, a user, such as a physician, may upload a clinical visit audio between a patient and the physician to the input interface in order to generate a transcript and a summary based on the audio. The input interface may provide the audio file to an audio storage and also provide the metadata for the audio file to a metadata managing system. In some embodiments, a user of the medical audio summarization service 210 may indicate the medical conversation is to be summarized according to a preferred style by indicating a stored audio file in the audio storage for the medical audio summarization service 210 to summarize along with an indication of the preferred style. In some embodiments, the indication of the medical conversation to be summarized with the summary conforming to the user preferred summarization style may be a selection of the preferred summarization style from a set of available summarization styles. For example, the user may select as the user preferred style. For example, the style selection may be performed using a dropdown menu of the input interface that displays a list of available summarization styles. In some embodiments, the preferred summarization style may be indicated using a user provided summary sample. For example, the input interface may be configured to allow a user to upload (or otherwise indicate an uploaded one of) a medical conversation summary sample as an indication of the user preferred style. In some embodiments, the input interface may classify the user provided sample as one of a set of available summarization styles, wherein the classified style is used as the user preferred style. In some embodiments, the available summarization styles may be styles that a large language model has been trained to generate. For example, the available summarization styles may be summarization styles that the large language model 236 has been trained to generate. In some embodiments, a user setting interface may receive user preferences and/or user provided training data. For example, a user may indicate one or more summarization preference settings including a preferred style to be used as a default preferred style in the absence of a style selection and/or a user provided summary sample. In some embodiments, a customer may provide a sample medical conversation summary to use as the default preferred style, wherein summaries generated by the medical audio summarization service 210 are generated based on the user provided sample.

In some embodiments, the input interface may receive an indication of a medical conversation to be summarized and generate a job request, requesting a summary be generated for the medical conversation. The medical audio summarization service 210 may send the job request to summarization task processing engine 232. Once summarization task processing engine 232, receives the job request, summarization task processing engine 232 may access the audio file and the metadata of the medical conversation from the audio storage and the metadata managing system, respectively. A control plane 220 may send the job request to be queued to a job queue, in some embodiments. Automatic speech recognition transcription 212 may then process the job request from the job queue and generate a transcript of the medical conversation. For example, automatic speech recognition transcription 212 may be implemented end-to-end automatic speech recognition models based on Connectionist Temporal Classification (CTC) which encode acoustic features from the audio data, generate possible transcriptions, select from among the possible transcriptions using one or more scoring techniques, and then provide as the transcription the selected possible transcription (e.g., decoded from the encoded acoustic features). In some embodiments, the results may be provided cause a results notification. The results notification indicating generation of the transcript may be provided to the task summarization processing engine 232. In some embodiments, a first amount of audio data of the medical conversation may be provided to the automatic speech recognition transcription 212, while the patient and physician are still talking and generating a second (or subsequent) amount of the audio data (e.g., a real-time, live, or streaming scenario for medical audio summarization. For example, the medical conversation may be provided to the automatic speech recognition transcription 212 as an audio input stream. The transcript may be generated based on the first amount of audio data and the automatic speech recognition transcription 212 may receive the second amount of the audio data while continuing to generate the transcript. For example, the transcript may be generated during a clinical visit.

In some embodiments, a summarization task processing engine 232 may receive notification of a job request to generate a summary conforming to a user preferred style selected from a set of available styles (or no style at all). The summarization task processing engine 232 may also receive the transcript needed for the job request via a transcript retrieval interface. Notification of the job request and the transcript may be provided to a control plane 220 (or workload distribution 234) for the summarization task processing engine 232 and the job request and transcript may be provided to a job queue. A summarization task processing engine 232 may be instantiated by the control plane 220 and may receive the job request and the transcript from the job queue. In some embodiments, the summarization task processing engine 232 may then invoke machine learning models such as a medical entity detection model to identify medical entities and a role identification model to identify speaker roles, wherein the medical entity detection model and the role identification model are discretely trained for the specific entity detection/role identification. The workflow processing engine 130 may also invoke the large language model 236 to generate a summary, wherein the large language model takes as inputs outputs generated using the previous models. For example, summary inferences may be generated using the large language model and a transcript that has been marked with medical entities and speaker roles using the medical entity detection model and the role identification model.

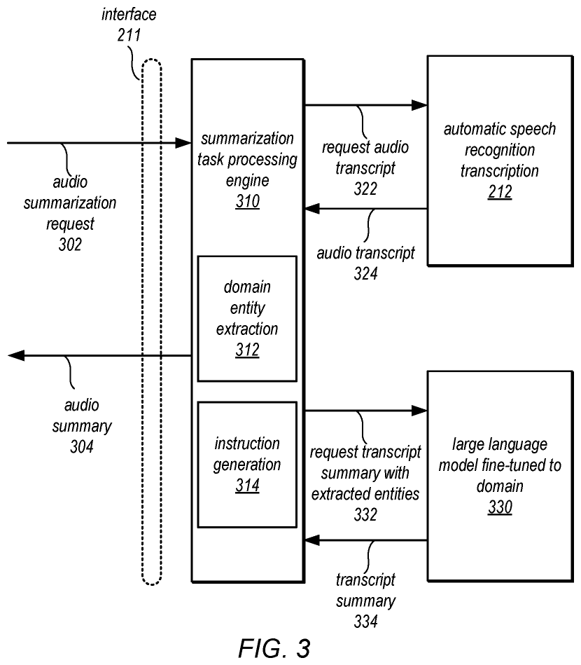

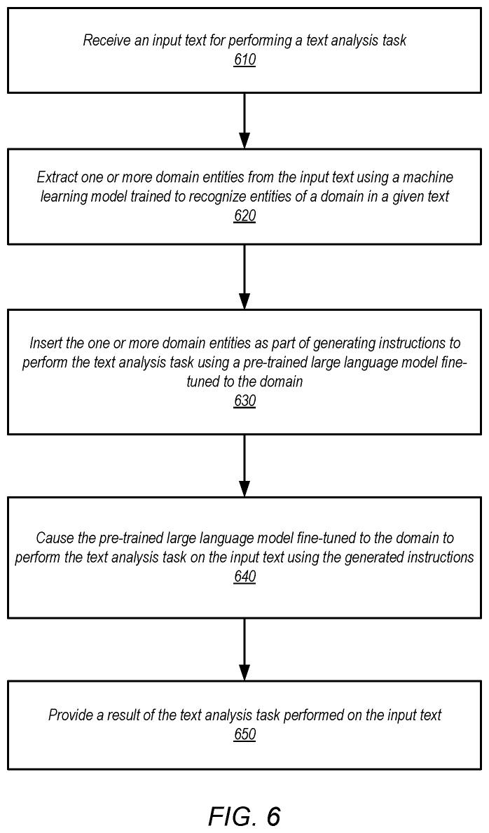

In some embodiments, a computing instance instantiated as a summarization task processing engine 232 may access respective ones of the models 236 with domain-specific fine-tuning 238 to perform discrete tasks, such as medical entity detection, role identification, and various summarization tasks, such as sectioning, extraction, and abstraction. The summarization task processing engine 232 may merge results from each task into a current version of the transcript that is being updated as the discrete tasks are performed. The currently updated (and merged) version of the transcript may be used as an input to perform respective ones of the subsequent discrete tasks. For example, in some embodiments, the summarization task processing engine 232 may merge the results from a task performed using a prior model with the transcript and use the merged transcript to determine results for a task that uses the next model. For example, a workflow worker instance of the summarization task processing engine 232 may invoke a medical entity detection model to identify medical entities in a transcript. The results may then be merged with the transcript to include in the original transcript the identified medical entities. The workflow worker instance may then invoke the role identification model to identify speaker roles in the merged transcript. The identified speaker role results may then be merged with the merged transcript to include the identified medical entities and identified speaker roles. In some embodiments, the large language model 236 may generate a summary based on the updated version of the transcript and using domain specialty prompt instructions, as discussed in detail below with regard to FIGS. 3 and 6.

In some embodiments, the respective machine learning models may be used in different orders, but may be trained in whichever order the machine learning models are to be used. For example, in some embodiments, speaker role identification may be performed before medical entity identification, but in such a case, the medical entity identification model may be trained using training data this is output from the speaker role identification task. In other embodiments, medical entity identification may be performed prior to speaker role identification, in which case the speaker role identification model may be trained using training data that is output from the medical entity identification task. In some embodiments, the transcript may be merged with the results of a preceding model before being used for a future model.

In some embodiments, the language model 236 may perform one or more of the discrete tasks discussed above (such as medical entity detection, role identification, etc.) update to the transcript. The large language model 236 may perform multiple ones of a set of discrete tasks, such as sectioning, extraction, and abstraction, as a single script modification task. In some embodiments, the large language model 236 may perform additional ones of the discrete tasks discussed above, such as medical entity detection and role identification, and, in which case, directly use the transcript from the summarization task processing engine 232 to generate the summary.

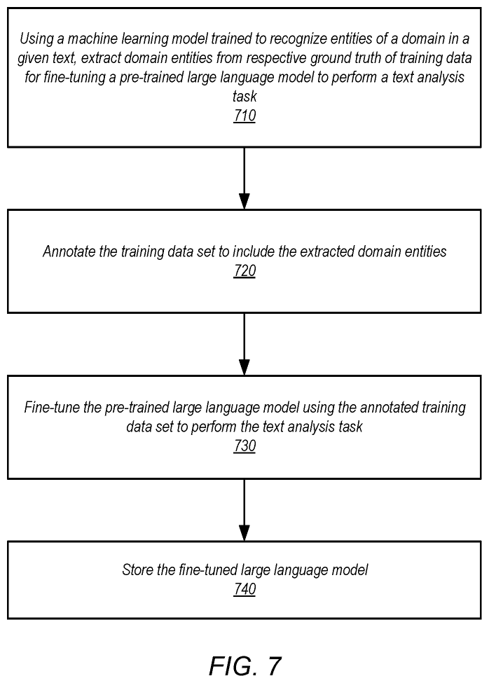

In some embodiments, a model training coordinator 235 may be used for training the machine learning models with labeled training data, such as annotated transcripts. The model training coordinator 235 may use labeled training data 244 that comprise previously provided summaries and summary interaction metadata to train the large language model 236. Training of the large language model 236 is further discussed in detail in regard to FIGS. 4 and 7 and may use domain entity extraction 237 and domain entity data augmentation 239, in some embodiments, for fine-tuning large language models, such as large language model 236, to a specific domain. In some embodiments, the model training coordinator 242 may be used offline.

Once the summary is generated, the summarization task processing engine 232 may provide the generated summary to an output interface. The output interface may notify the customer of the completed job request. In some embodiments, the output interface may provide a notification of a completed job to the output API. In some embodiments, the output API may be implemented to provide the summary for upload to an electronic health record (EHR) or may push the summary out to an electronic health record (EHR), in response to a notification of a completed job.

FIG. 3 illustrates a logical block diagram of different interactions to perform text summarizations using domain entity extraction, according to some embodiments. Summarization task processing engine 310 may receive requests via interface 211 (and workload distribution 234) for handling an audio summarization request 302. The audio data may be identified or provided in request 302. Summarization task processing engine may request audio transcript 322 for the audio data from automatic speech recognition transcription 212, in some embodiments. Automatic speech recognition transcription 212 may utilize various audio processing techniques, such as deep neural network based speech recognition models, to generate a transcript of speech in the audio data and provide the audio transcript 324 to summarization task processing engine 310.

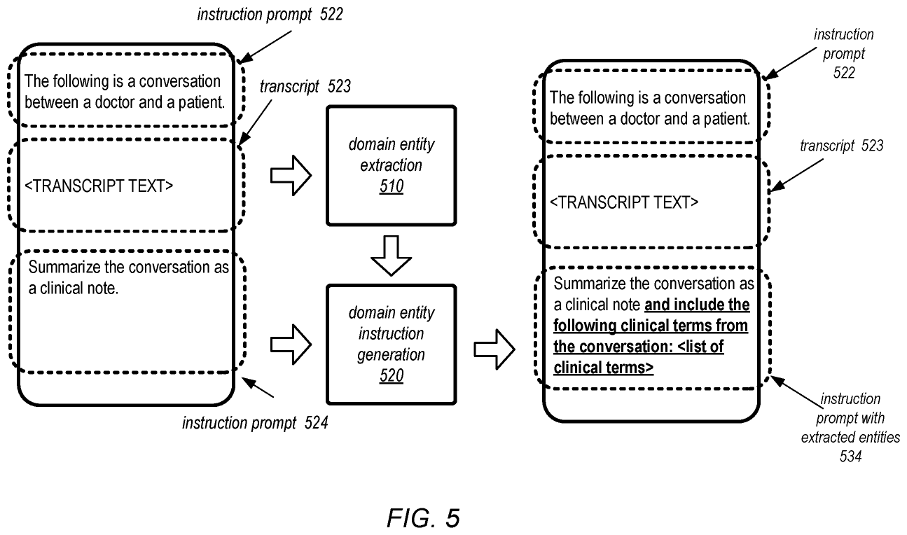

Summarization task processing engine 310 may implement domain entity extraction 312. Domain entity extraction 312 may perform entity recognition (e.g., parsing words from the audio transcript and performing entity classification using similarity indexes, machine learning models, or applying other techniques on the words from the transcript) to identify the domain entities present in the audio transcript for the summarization request. For example, an NER model may be used which is trained for the medical domain (other NER models could be trained for other domains and used similarity for other services providing text analysis tasks that take advantage of domain entity extraction). The domain entities found by domain entity extraction 312 may then be provided to instruction generation 314. Instruction generation 314 may generate and include the domain entit(ies) in the instructions to perform text summarization (e.g., as exemplified in the discussion of FIG. 5 below). Summarization task processing engine 310 may request 332 transcript summary with the domain entities from large language model that is fine-tuned to the domain 330, in some embodiments. The generated transcript summary 334 may be returned and included in audio summary response 304.

FIG. 4 illustrates a logical block diagram of fine-tuning a pre-trained large language model for performing text summarizations using domain entity extraction, according to some embodiments. A request to fine-tune a pre-trained large language model 402 may be received via interface 211 and directed to model training coordinator 235. The request may identify or reference the domain to add (e.g., a particular healthcare domain, such as cardiology, neurology, etc.). Model training coordinator 235 may get 422 the training data from fine-tuning data set 420 and apply domain specialty data augmentation 239 to identify and add specialty identifiers for the new domain specialty according to the definition. Similar to domain entity extraction 312 above, an NER model may be used to recognize entities, terms or other text in fine-tuning training data set that are common to the domain. The augmented training data 424 may then be stored.

Model training coordinator 432 may then send a training job to training host(s) 430, which may execute the training job that fine-tunes the large language model tuned to the domain 440, by getting the model 442 and getting the augmented training data 426, executing a fine-tuning technique at training hosts 430. As discussed above, such tuning techniques may include generating instructions to perform text analysis task(s), such as text summarization, as well as including extracted domain entities to include with the instructions. When fine-tuning is complete, the training host(s) 430 may store the further-tuned model 444 and provide an indication that the training job is complete 434 to model training coordinator 235. Model training coordinator 235 may then acknowledge the addition of the domain specialty, as indicated at 404.

FIG. 5 illustrates a logical block diagram of extracted domain entities included instructions to perform a summarization task using a large language model, according to some embodiments. Domain entity extraction 510 may take a given transcript 523 and an apply a machine learning model that recognizes medical or other entities, such as clinical terms from the transcript (e.g., similar to the techniques discussed above at 237 and 312 in FIGS. 2-4). Domain entity instruction generation 520 may insert the recognized entities (e.g., the clinical terms) into an instruction prompt, as indicated at 534. For example, the insertion may request that the following terms be included in the result of the summary. While instruction prompt 524 may have changed, transcript 523 and instruction prompt 522 may remain unchanged, in some embodiments.

Although FIGS. 2-5 have been described and illustrated in the context of a provider network implementing a medical audio summarization service, the various components illustrated and described in FIGS. 2-5 may be easily applied to other systems that implement text analysis tasks, either standalone systems or implemented as a feature of a larger application. For example, other services that receive text from an external system or source (e.g., a client document) may perform various text analysis tasks, including but not limited text summarization, question answering, drafting additional text, such as introductions or conclusions, performing comparisons between multiple texts, and text translation. As such, FIGS. 2-5 are not intended to be limiting as to other embodiments of domain specialty instruction generation for performing text analysis tasks.

FIG. 6 illustrates a high-level flowchart of various methods and techniques to implement domain entity extraction for performing text analysis tasks, according to some embodiments. Various different systems and devices may implement the various methods and techniques described below, either singly or working together. Therefore, the above examples and or any other systems or devices referenced as performing the illustrated method, are not intended to be limiting as to other different components, modules, systems, or devices.

As indicated at 610, an input text for performing a text analysis task may be received, in some embodiments. The input text may be received from a variety of sources. For example, the input text may be received from another system, such an automatic speech recognition system that captured or transcribed the text from audio or video sources. In some embodiments, the text may be captured from image data featuring text upon which optical character recognition techniques are performed to generate text or various types of documents, both human readable documents or documents written according to a file format or schema such as Javascript Object Notation (JSON). In some embodiments, the text may be received as part of a request to perform a text analysis task (or multiple text analysis tasks). In some embodiments, the text may be received as part of a batch text that is operated upon in batch processing fashion (e.g., batch processing of multiple text files for performing the same text analysis task). In some embodiments, text may be received as part of a real-time text analysis job or scenario (e.g., for real-time transcription and summarization).

In some embodiments, different domains may be supported. One of the domains may be selected as part of a request, in some embodiments, to perform the text analysis task. For example, if medical, legal, or various scientific domains are supported, then the request may include a selection of one of these domains. Corresponding machine learning models for entity recognition and pre-trained large language models fine-tuned to the domain may be identified (e.g., legal entity extraction models and fine-tuned large language models may be identified and used). In some embodiments, other features (in addition to or instead of the request) may be considered to determine the domain. For example, the source, such as the user account or other identifiers of a client that submitted the text may be used to identify the domain.

As indicated at 620, one or more domain entities may be extracted from the input text using an machine learning model trained to recognize entities of a domain in a given text, in some embodiments. As discussed above, different techniques the input text may be parsed, tokenized, transformed into a feature vector or other representation which may be input to a classification system (e.g., using machine-learning models) or a similarity search (e.g., using a similarity index or other search technique that evaluates possible domain specialties) to identify the domain-specialty. An NER model is one example of such a technique. NER models may be generally domain-specific or in some cases a custom entity recognition model (which may have been specifically trained for a user that is performing the text analysis task). For the custom NER model, the request to perform text analysis tasks could identify the NER model to use or may allow for a text analysis system to select a domain default NER model.

As indicated at 630, the one or more domain entities may be inserted as part of generating instructions to perform the text analysis task using a pre-trained large language model fine-tuned to the domain, in some embodiments. For example, as discussed above the domain entities may be included and used to guide generation of the result of the text analysis task. For a summarization task, the instructions could ask for the domain entities to be included in the summary. For a question answering task, the instructions could ask for the answer to use each of the domain entities in generating the answer. For comparison, the instructions could request that the domain entities to be considered in each text and the comparison showing any differences or similarities in their use. Various other possible instructions that use the domain entities in the may be generated according to the performed text analysis task.

As indicated at 640, the pre-trained large language model fine-tuned to the domain may be caused to perform the text analysis task on the input text using the generated instructions that include the domain entities, in some embodiments. For example, an API call, interface command, instruction, or other trigger to perform the text analysis task using the inserted domain specialty identifiers in the generated instructions may be used to invoke a host system for the pre-trained large language model to perform the text analysis. In some embodiments, the pre-trained large language model may be local (e.g., on the same host as the other features of an application, system, or service performing the text analysis task) or located remote on another system accessed over a network connection.

As indicated at 650, a result of the text analysis task performed on the input text, in some embodiments. For example, an interface may display the result, or the result may be stored in a specified location, or the result may be passed to another system for further downstream processing or operations (e.g., text-to-speech operations to playback the summary in speech).

FIG. 7 illustrates a high-level flowchart of various methods and techniques to implement fine-tuning a pre-trained large language model for a domain entity extraction for performing text analysis tasks, according to some embodiments. As indicated at 710, a machine learning model trained to recognize entities of a domain in a given text may be used to extract domain entities from respective ground truth of training data for fine-tuning a pre-trained large language model to perform a text analysis task, in some embodiments. A request to perform fine-tuning or other instruction may be received that causes domain entity extraction. Similar to element 620 above, different techniques the input text may be parsed, tokenized, transformed into a feature vector or other representation which may be input to a classification system (e.g., using machine-learning models) or a similarity search (e.g., using a similarity index or other search technique that evaluates possible domain specialties) to identify the domain-specialty. An NER model is one example of such a technique. NER models may be generally domain-specific or in some cases a custom entity recognition model (which may have been specifically trained for a user that is performing the text analysis task). For the custom NER model, the request to perform fine-tuning could identify the NER model to use or may allow for a text analysis system to select a domain default NER model.

As indicated at 720, the training data set may be annotated to include the extracted domain entities, in some embodiments. Training data may be annotated in order to incorporate domain entit(ies) for performing fine-tuning. For instance, each training example may be updated to include the domain entities extracted from that example.

As indicated at 730, the pre-trained large language model may be fine-tuned using the annotated training data set to perform a text analysis task, in some embodiments. For example, tuning techniques may include generating instructions to perform text analysis task(s), such as text summarization, as well as including extracted domain entities to include with the instructions (as discussed in detail above with regard to 630).

As indicated at 740, the fine-tuned large language model may be stored, in some embodiments. For example, a model store may be maintained that is used to maintain different fine-tuned models for different use cases (e.g., different text analysis tasks or domains). These fine-tuned models can then be retrieved and deployed for different text analysis systems from storage.

The methods described herein may in various embodiments be implemented by any combination of hardware and software. For example, in one embodiment, the methods may be implemented on or across one or more computer systems (e.g., a computer system as in FIG. 8) that includes one or more processors executing program instructions stored on one or more computer-readable storage media coupled to the processors. The program instructions may implement the functionality described herein (e.g., the functionality of various servers and other components that implement the network-based virtual computing resource provider described herein). The various methods as illustrated in the figures and described herein represent example embodiments of methods. The order of any method may be changed, and various elements may be added, reordered, combined, omitted, modified, etc.

Embodiments of domain specialty instruction generation for performing text analysis tasks as described herein may be executed on one or more computer systems, which may interact with various other devices. One such computer system is illustrated by FIG. 8. In different embodiments, computer system 1000 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing device, computing node, compute node, or electronic device.

In the illustrated embodiment, computer system 1000 includes one or more processors 2110 coupled to a system memory 1020 via an input/output (I/O) interface 1030. Computer system 1000 further includes a network interface 1040 coupled to I/O interface 1030, and one or more input/output devices 1050, such as cursor control device 1060, keyboard 1070, and display(s) 1080. Display(s) 1080 may include standard computer monitor(s) and/or other display systems, technologies or devices. In at least some implementations, the input/output devices 1050 may also include a touch- or multi-touch enabled device such as a pad or tablet via which a user enters input via a stylus-type device and/or one or more digits. In some embodiments, it is contemplated that embodiments may be implemented using a single instance of computer system 1000, while in other embodiments multiple such systems, or multiple nodes making up computer system 1000, may host different portions or instances of embodiments. For example, in one embodiment some elements may be implemented via one or more nodes of computer system 1000 that are distinct from those nodes implementing other elements.

In various embodiments, computer system 1000 may be a uniprocessor system including one processor 2110, or a multiprocessor system including several processors 2110 (e.g., two, four, eight, or another suitable number). Processors 2110 may be any suitable processor capable of executing instructions. For example, in various embodiments, processors 2110 may be general-purpose or embedded processors implementing any of a variety of instruction set architectures (ISAs), such as the x86, PowerPC, SPARC, or MIPS ISAs, or any other suitable ISA. In multiprocessor systems, each of processors 2110 may commonly, but not necessarily, implement the same ISA.

In some embodiments, at least one processor 2110 may be a graphics processing unit. A graphics processing unit or GPU may be considered a dedicated graphics-rendering device for a personal computer, workstation, game console or other computing or electronic device. Modern GPUs may be very efficient at manipulating and displaying computer graphics, and their highly parallel structure may make them more effective than typical CPUs for a range of complex graphical algorithms. For example, a graphics processor may implement a number of graphics primitive operations in a way that makes executing them much faster than drawing directly to the screen with a host central processing unit (CPU). In various embodiments, graphics rendering may, at least in part, be implemented by program instructions that execute on one of, or parallel execution on two or more of, such GPUs. The GPU(s) may implement one or more application programmer interfaces (APIs) that permit programmers to invoke the functionality of the GPU(s). Suitable GPUs may be commercially available from vendors such as NVIDIA Corporation, ATI Technologies (AMD), and others.

System memory 1020 may store program instructions and/or data accessible by processor 2110. In various embodiments, system memory 1020 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing desired functions, such as ratio mask post-filtering for audio enhancement as described above are shown stored within system memory 1020 as program instructions 1025 and data storage 1035, respectively. In other embodiments, program instructions and/or data may be received, sent or stored upon different types of computer-accessible media or on similar media separate from system memory 1020 or computer system 1000. Generally speaking, a non-transitory, computer-readable storage medium may include storage media or memory media such as magnetic or optical media, e.g., disk or CD/DVD-ROM coupled to computer system 1000 via I/O interface 1030. Program instructions and data stored via a computer-readable medium may be transmitted by transmission media or signals such as electrical, electromagnetic, or digital signals, which may be conveyed via a communication medium such as a network and/or a wireless link, such as may be implemented via network interface 1040.

In one embodiment, I/O interface 1030 may coordinate I/O traffic between processor 2110, system memory 1020, and any peripheral devices in the device, including network interface 1040 or other peripheral interfaces, such as input/output devices 1050. In some embodiments, I/O interface 1030 may perform any necessary protocol, timing or other data transformations to convert data signals from one component (e.g., system memory 1020) into a format suitable for use by another component (e.g., processor 2110). In some embodiments, I/O interface 1030 may include support for devices attached through various types of peripheral buses, such as a variant of the Peripheral Component Interconnect (PCI) bus standard or the Universal Serial Bus (USB) standard, for example. In some embodiments, the function of I/O interface 1030 may be split into two or more separate components, such as a north bridge and a south bridge, for example. In addition, in some embodiments some or all of the functionality of I/O interface 1030, such as an interface to system memory 1020, may be incorporated directly into processor 2110.

Network interface 1040 may allow data to be exchanged between computer system 1000 and other devices attached to a network, such as other computer systems, or between nodes of computer system 1000. In various embodiments, network interface 1040 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 1050 may, in some embodiments, include one or more display terminals, keyboards, keypads, touchpads, scanning devices, voice or optical recognition devices, or any other devices suitable for entering or retrieving data by one or more computer system 1000. Multiple input/output devices 1050 may be present in computer system 1000 or may be distributed on various nodes of computer system 1000. In some embodiments, similar input/output devices may be separate from computer system 1000 and may interact with one or more nodes of computer system 1000 through a wired or wireless connection, such as over network interface 1040.

As shown in FIG. 8, memory 1020 may include program instructions 1025, that implement the various methods and techniques as described herein, including the application of self-supervised training for audio anomaly detection and data storage 1035, comprising various data accessible by program instructions 1025. In one embodiment, program instructions 1025 may include software elements of embodiments as described herein and as illustrated in the Figures. Data storage 1035 may include data that may be used in embodiments. In other embodiments, other or different software elements and data may be included.

Those skilled in the art will appreciate that computer system 1000 is merely illustrative and is not intended to limit the scope of the techniques as described herein. In particular, the computer system and devices may include any combination of hardware or software that can perform the indicated functions, including a computer, personal computer system, desktop computer, laptop, notebook, or netbook computer, mainframe computer system, handheld computer, workstation, network computer, a camera, a set top box, a mobile device, network device, internet appliance, PDA, wireless phones, pagers, a consumer device, video game console, handheld video game device, application server, storage device, a peripheral device such as a switch, modem, router, or in general any type of computing or electronic device. Computer system 1000 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a non-transitory, computer-accessible medium separate from computer system 1000 may be transmitted to computer system 1000 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

It is noted that any of the distributed system embodiments described herein, or any of their components, may be implemented as one or more web services. In some embodiments, a network-based service may be implemented by a software and/or hardware system designed to support interoperable machine-to-machine interaction over a network. A network-based service may have an interface described in a machine-processable format, such as the Web Services Description Language (WSDL). Other systems may interact with the web service in a manner prescribed by the description of the network-based service's interface. For example, the network-based service may describe various operations that other systems may invoke, and may describe a particular application programming interface (API) to which other systems may be expected to conform when requesting the various operations.

In various embodiments, a network-based service may be requested or invoked through the use of a message that includes parameters and/or data associated with the network-based services request. Such a message may be formatted according to a particular markup language such as Extensible Markup Language (XML), and/or may be encapsulated using a protocol such as Simple Object Access Protocol (SOAP). To perform a web services request, a network-based services client may assemble a message including the request and convey the message to an addressable endpoint (e.g., a Uniform Resource Locator (URL)) corresponding to the web service, using an Internet-based application layer transfer protocol such as Hypertext Transfer Protocol (HTTP).

In some embodiments, web services may be implemented using Representational State Transfer (“RESTful”) techniques rather than message-based techniques. For example, a web service implemented according to a RESTful technique may be invoked through parameters included within an HTTP method such as PUT, GET, or DELETE, rather than encapsulated within a SOAP message.

The various methods as illustrated in the FIGS. and described herein represent example embodiments of methods. The methods may be implemented in software, hardware, or a combination thereof. The order of method may be changed, and various elements may be added, reordered, combined, omitted, modified, etc.

Various modifications and changes may be made as would be obvious to a person skilled in the art having the benefit of this disclosure. It is intended that the invention embrace all such modifications and changes and, accordingly, the above description to be regarded in an illustrative rather than a restrictive sense.

What is claimed is:

1. A system, comprising:
one or more computing devices, respectively comprising at least one processor and a memory;
wherein the one or more computing devices store program instructions that when executed by the one or more computing devices:
receive a request to perform a summarization task on a natural language text;
extract one or more domain entities from the natural language text using a machine learning model trained to recognize entities of a domain in a given text;
insert the one or more domain entities as part of generating instructions to perform the summarization task using a pre-trained large language model fine-tuned to the domain;
cause the pre-trained large language model fine-tuned to the domain to perform the summarization task on the natural language text using the generated instructions; and
provide a result of the summarization task performed on the natural language text.

2. The system of claim 1, wherein the instructions to perform the summarization task specify that the one or more domain entities are to be included in the result of the summarization task

3. The system of claim 1, wherein the one or more computing devices store further program instructions that when executed by the one or more computing devices generate the natural language text as a transcript from obtained audio data using an automatic speech recognition system.

4. The system of claim 1, wherein the one or more computing devices are implemented as part of a medical audio summarization service offered as part of a provider network and wherein the request is received via an interface of the medical audio summarization service.

5. A method, comprising:
receiving, at a text analysis system, an input text for performing a text analysis task;
extracting, by the text analysis system, one or more domain entities from the input text using a machine learning model trained to recognize entities of a domain in a given text;
inserting, by the text analysis system, the one or more domain entities as part of generating instructions to perform the text analysis task using a pre-trained large language model fine-tuned to the domain;
causing, by the text analysis system, the pre-trained large language model fine-tuned to the domain to perform the text analysis task on the input text using the generated instructions; and
providing, by the text analysis system, a result of the text analysis task performed on the input text.

6. The method of claim 5, further comprising generating the input text as a transcript from obtained audio data using an automatic speech recognition system.

7. The method of claim 5, wherein the instructions to perform the text analysis task specify that the one or more domain entities are to be included in the result of the text analysis task.

8. The method of claim 5, further comprising receiving, at the text analysis system, a selection of the domain out of a plurality of domains supported by the text analysis system, wherein the machine learning model and the pre-trained large language model correspond to the selected domain and are respectively selected for performing the text analysis task out of respective pluralities of machine learning models that recognize entities out of different ones of the plurality of domains and pre-trained large language models fine-tuned to the different ones of the plurality of domains.

9. The method of claim 5, further comprising:
receiving a request to fine-tune the pre-trained large language model for one or more additional domain entities, wherein the request identifies further training data for the fine-tuning that includes one or more additional domain entities in ground truth data; and
performing further fine-tuning on the pre-trained large language model for the domain using the further training data annotated with the one or more additional domain entities extracted from the ground truth data.

10. The method of claim 5, wherein the pre-trained large language model is fine-tuned to the domain using domain entities extracted from ground truth data included in the training data set.

11. The method of claim 5, wherein extracting the one or more domain entities from the input text using the machine learning model trained to recognize entities of the domain in the given text comprises sending one or more requests to a remote host for the machine learning model to perform recognition on the input text.

12. The method of claim 5, wherein the text analysis task is a summarization task.

13. The method of claim 5, wherein the text analysis system is implemented as part of a medical audio summarization service offered as part of a provider network and wherein the input text is received via an interface of the medical audio summarization service.

14. One or more non-transitory, computer-readable storage media, storing program instructions that when executed on or across one or more computing devices cause the one or more computing devices to implement:
receiving an input text for performing a text analysis task;
extracting one or more domain entities from the input text using a machine learning model trained to recognize entities of a domain in a given text;
inserting the one or more domain entities as part of generating instructions to perform the text analysis task using a pre-trained large language model fine-tuned to the domain;
causing the pre-trained large language model fine-tuned to the domain to perform the text analysis task on the input text using the generated instructions; and
providing a result of the text analysis task performed on the input text.

15. The one or more non-transitory, computer-readable storage media of claim 14, storing further program instructions that when executed by the one or more computing devices, cause the one or more computing devices to further implement generating the input text as a transcript from obtained audio data using an automatic speech recognition system.

16. The one or more non-transitory, computer-readable storage media of claim 14, wherein the instructions to perform the text analysis task specify that the one or more domain entities are to be included in the result of the text analysis task.

17. The one or more non-transitory, computer-readable storage media of claim 14, storing further program instructions that when executed by the one or more computing devices, cause the one or more computing devices to further implement receiving, at the text analysis system, a selection of the domain out of a plurality of domains supported by the text analysis system, wherein the machine learning model and the pre-trained large language model correspond to the selected domain and are respectively selected for performing the text analysis task out of respective pluralities of machine learning models that recognize entities out of different ones of the plurality of domains and pre-trained large language models fine-tuned to the different ones of the plurality of domains.

18. The one or more non-transitory, computer-readable storage media of claim 14, storing further program instructions that when executed by the one or more computing devices, cause the one or more computing devices to further implement:
receiving a request to fine-tune the pre-trained large language model for one or more additional domain entities, wherein the request identifies further training data for the fine-tuning that includes one or more additional domain entities in ground truth data; and
performing further fine-tuning on the pre-trained large language model for the domain using the further training data annotated with the one or more additional domain entities extracted from the ground truth data.

19. The one or more non-transitory, computer-readable storage media of claim 14, wherein the pre-trained large language model is fine-tuned to the domain using domain entities extracted from ground truth data included in the training data set.

20. The one or more non-transitory, computer-readable storage media of claim 14, wherein the one or more computing devices are implemented as part of a medical audio summarization service offered as part of a provider network and wherein the input text is received via an interface of the medical audio summarization service.
